(19) United States
(12) Patent Application Publication
(10) Pub. No.: US 2019/0011007 A1
(43) Pub. Date: Jan. 10, 2019

(54) MOLYBDENUM COATED ELEVATOR SAFETY BRAKES

(71) Applicant: Otis Elevator Company, Farmington, CT (US)

(72) Inventors: Aaron T. Nardi, East Granby, CT (US); Robert A. Barth, South Windsor, CT (US); Xiaodong Luo, South Windsor, CT (US); Mark Steven Thompson, Tolland, CT (US); Michael A. Klecka, Coventry, CT (US)

(21) Appl. No.: 16/068,008

(22) PCT Filed: Jan. 4, 2017
(86) PCT No.: PCT/US2017/012187

§ 371 Date: Jul. 3, 2018

Related U.S. Application Data
(60) Provisional application No. 62/274,635, filed on Jan. 4, 2016.

(51) Int. Cl. F16D 69/02; B66B 5/22; F16D 69/04

(52) U.S. Cl. CPC F16D 69/027; F16D 2069/002; F16D 69/04; B66B 5/22

(57) ABSTRACT

An elevator safety brake for stopping an elevator car, the brake including a brake shoe including a base, and a brake pad disposed on the base, wherein the brake pad includes a rail contacting friction surface for contacting an elevator guide rail surface, wherein the brake pad is fuse bonded to the base, wherein the brake pad is chosen from a group consisting of: molybdenum and molybdenum alloys.

### CROSS-REFERENCE TO RELATED APPLICATIONS

The present application is an international patent application, which claims priority to 62/274,635, filed Jan. 4, 2016, which is incorporated in its entirety.

### TECHNICAL FIELD OF THE DISCLOSED EMBODIMENTS

The present invention generally relates to a safety braking system for slowing or stopping a vertically moving object, such as an elevator car, in an over speed condition. More particularly, the present invention relates to an elevator safety brake system for slowing or stopping an elevator car having a molybdenum coated safety brake pad.

### BACKGROUND OF THE DISCLOSED EMBODIMENTS

A typical safety braking system is attached to an elevator car and includes a pair of wedge shaped brake shoes having substantially flat frictional surfaces. The flat frictional surfaces are ordinarily positioned on opposite sides of the stem portion of a T shaped guide rail supported on an elevator hoistway wall. These wedge shaped brake shoes are activated by a governor mechanism which forces the wedge shaped brake shoes along an adjacent guide shoe assembly which in turn forces the frictional surfaces of the brake shoes to make contact with the guide rail to slow or stop the car.

In a typical safety braking system, the wedges may be loaded with up to approximately 56,000 lb. (250,000 N) normal force by applying approximately 8000 psi over a 7 in² surface (55,000 kPa×0.0045 m²). Using cast iron frictional surfaces having a nominal coefficient of friction with respect to the guide rail at approximately 6 m/s of approximately 0.15, the 56,000 lb. (250,000 N) force acting upon a wedge creates a frictional force of approximately 11,200 lb. (50,000 N) on the frictional surface of the wedge. In a conventional elevator cab design using cast iron frictional surfaces, there are four frictional surfaces which generate a total potential stopping force of approximately 45,000 lb. (200,000 N).

As very tall buildings are built, high speed, high load elevators (typically 4 to 8 m/s but up to 12.5 m/s) have become necessary to service the numerous floors in such buildings. Such elevators have a load rating of up to about 16,000 kg. The safety breaking requirements of such elevators have become increasingly demanding. It has been determined that conventional gray cast iron cannot operate as a consistent friction material at high speeds and loads required by such modern elevator systems due to braking failures caused by excessive wear and a reduced coefficient of friction caused by high frictional heating. In some applications, alternative friction materials are required which are typically more expensive than cast iron. To limit the amount of alternative material being used different forms (plate, sheet, etc.) mechanically attached to the surface of a steel substrate. Stresses from mechanical fastening increases the amount of the alternative friction materials required. As such, the cost of the brake system increases the overall cost of the elevator system. Accordingly, there is a need for elevator safety brake shoes made with alternative friction materials which provide a lower cost, low wear and consistent high friction to accommodate the high speeds and loads of elevators installed in very tall buildings.

### SUMMARY OF THE DISCLOSED EMBODIMENTS

In one aspect, an elevator safety brake for stopping an elevator car is provided. In any embodiment, the elevator safety brake includes a brake shoe including a base, and a brake pad disposed on the base, wherein the brake pad includes a rail contacting friction surface for contacting an elevator guide rail surface, wherein the brake pad is fuse bonded to the brake shoe, wherein the brake pad is chosen from a group consisting of: molybdenum and molybdenum alloys.

In any embodiment of the elevator safety brake, the base includes a high compressive strength structural alloy. In one embodiment the high compressive strength structural alloy is chosen from a group consisting of steel and cast iron.

In any embodiment of the elevator safety brake, the brake pad is fuse bonded to the base via a fusion welding process. In one embodiment, the fusion welding process includes an arc welding process.

In any embodiment of the elevator safety brake, the elevator safety brake further includes an interface layer disposed between the base and the brake pad, wherein the interface later fuse bonded to the base and the brake pad. In any embodiment of the elevator safety brake, the interface layer is chosen from a group consisting of: chrome, iron, nickel, nickel alloys, cobalt, and cobalt alloys.

In any embodiment of the elevator safety brake, the rail contacting friction surface includes surface features disposed thereon, wherein the surface features are configured to provide at least one of increased friction of the brake pad and wear indication of the brake pad.

In any embodiment of the elevator safety brake, the surface features may include at least one raised feature deposited onto at least one of the brake pad and the base.

In any embodiment of the elevator safety brake, the at least one raised feature may be non-continuously applied to at least one of the brake pad and the base.

In any embodiment of the elevator safety brake, the at least one raised feature may include a plurality of dots.

In any embodiment of the elevator safety brake, the at least one raised feature may include a plurality of line segments.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an elevator safety brake system according to an embodiment of the present disclosure;

FIG. 2 is a schematic diagram of an elevator safety brake according to an embodiment of the present disclosure;

FIG. 3 is a schematic diagram of an elevator safety brake including a cross-hatch pattern;

FIG. 4 is a schematic diagram of an elevator safety brake according to another embodiment of the present disclosure;

FIG. 5 is a schematic diagram of an elevator safety brake including a raised feature; and

FIG. 6 is a schematic diagram of an elevator safety brake including a raised feature.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

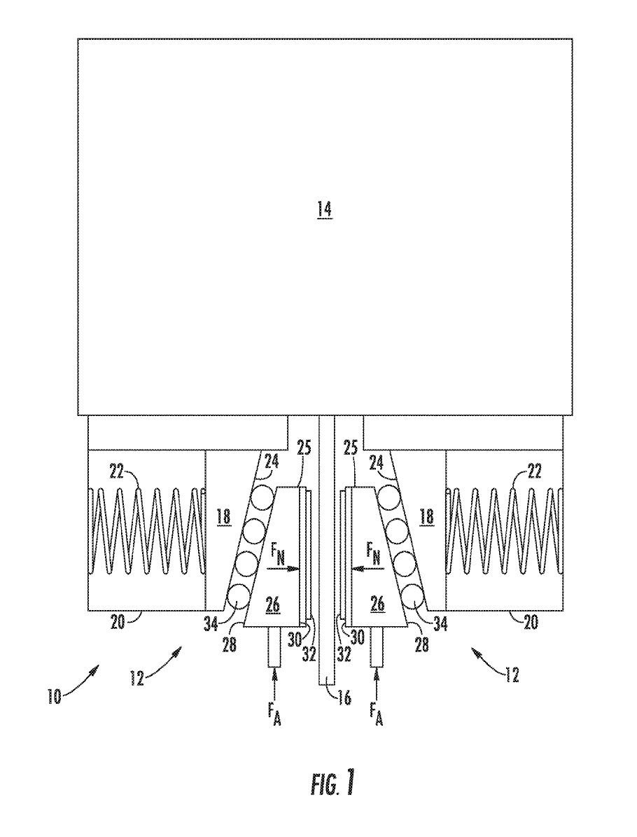

FIG. 1 provides a simplified schematic illustration of a known elevator safety brake system, generally indicated at 10. The brake system 10 includes a pair of actuators 12 which are attached to an elevator car 14 and positioned in an opposing relationship about a guide rail 16 supported in an elevator hoistway (not shown). The actuators 12 are formed, in part, by a wedge shaped guide shoe 18 which is movable within housing 20 in a direction which is generally perpendicular to the guide rail 16. The guide shoe 18 is biased towards the guide rail 16 by spring 22. The guide shoe 18 has an inclined cam surface 24. A wedge shaped brake shoe 25 having base 26 is provided so as to have an inclined cam surface 28 which is complimentary to the inclined cam surface 24 of the guide shoe 18. In an embodiment, the base 26 includes a high compressive strength structural alloy. In on embodiment, the high compressive strength structural alloy is chosen from a group consisting of steel and cast iron. It will be appreciated that other high compressive strength structural alloys may be chosen. The brake shoe 25 is also provided with a rail facing surface 30. The brake shoe 25 is positioned between the guide shoe 18 and the guide rail 16.

A brake pad 32 having a high friction material is disposed on the rail facing surface 30 of the brake shoe base 26. A roller cage assembly containing a plurality of rollers 34 is positioned between the inclined cam surface 24 of the guide shoe 18 and the complimentary inclined guide shoe facing surface 28 of the brake shoe 25. The rollers 34 provide a low friction contact between the complimentary inclined adjacent surfaces 24 and 28 of the guide shoe 18 and the brake shoe 25, respectively. The guide shoe 18, biased by spring 22, applies normal force F_{N} in the direction of the guide rail 16 on brake shoe 25 through rollers 34.

In an emergency or overspeed situation wherein the application of the brake system 10 is desired, a force F_{A} in the direction parallel to the guide rail 16 is applied to the wedge shaped brake shoes 25 which cause the brake shoes 25 to move towards the elevator car 14. Ordinarily, force F_{A} is supplied by a rope, cable or mechanical linkage connected to a governor (not shown). The inclined complimentary cam surfaces 24 and 28 of the guide shoe 18 and the brake shoe base 26, respectively, cause the brake shoe 25 to move towards the rail 16 until contact between the brake pad 32 and the guide rail 16 is made. For a brief moment, the brake pads 32 stop (friction on rail 16) while elevator car 14 continues down (via gravity). As those skilled in the art will appreciate, when engaged (e.g., the elevator car 14 now dragging the brake pad 32 on the guide rail 16), the brake pad 32 is applied to the guide rail 16 with normal force F_{N} supplied by the spring 22. The amount of braking force developed by normal force F_{N} is substantially and directly proportional to the friction coefficient μₖ between the high friction material used in the brake pad 32 and the guide rail material. As braking occurs, heat tends to become accumulated in the brake pad 32 which can deleteriously reduce the friction coefficient μₖ between the pad material and guide rail material. If the heat becomes high enough for a given material, a substantial reduction in the hardness, as well as deformation or fusion of the high friction material may occur, which in turn may cause brake failure.

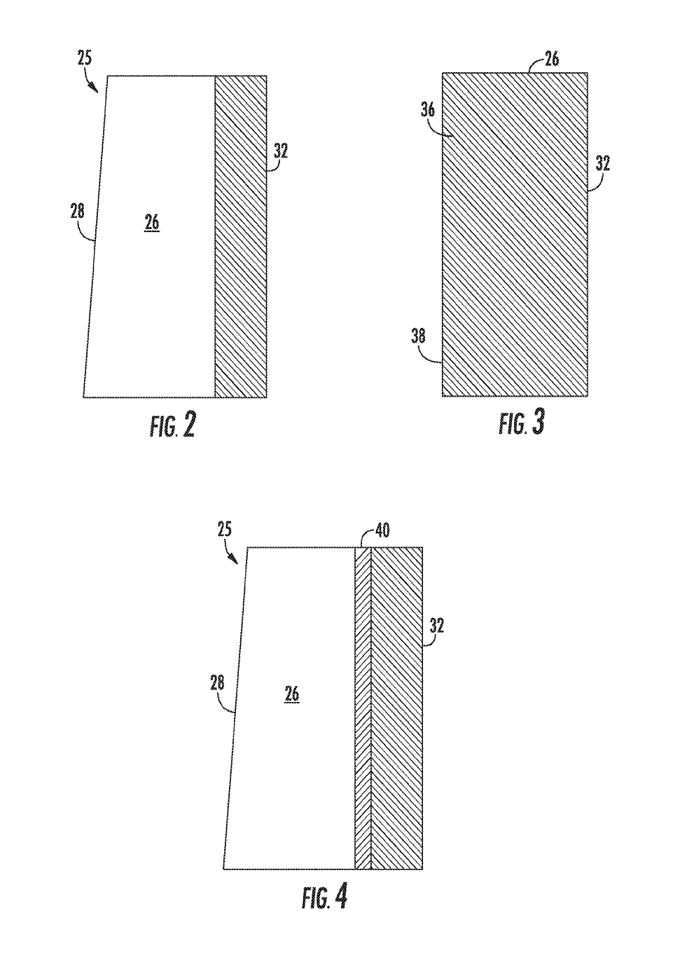

FIG. 2 illustrates an embodiment of a brake shoe 25, wherein the brake pad 32 is fuse bonded to brake shoe base 26, wherein the brake pad 32 is chosen from a group including molybdenum and molybdenum alloys, such as TZM to name one non-limiting example. In an embodiment, the coating of brake pad 32 is fuse bonded to the brake shoe base 26 via a fusion welding process. In one embodiment, the fusion welding process includes an arc welding process. It will be appreciated that the arc welding process may include a process in which the added metal is delivered through a metal or a powder to name a couple of non-limiting examples. It will further be appreciated, in other embodiments; the fusion welding process includes laser beam or electron beam welding process. The laser beam or electron beam welding process may include a process in which the added metal is delivered through a metal or a powder to name a couple of non-limiting examples.

In embodiment, as shown in FIG. 3, surface features 36 may be added to the brake pad friction surface 38 during the fusion welding process, the surface features 36 are configured to provide at least one of increased friction of the brake pad 32 and wear indication of the brake pad 32. For example, the surface features 36 may include cross hatch patterns, tiles, and buttons to name a few non-limiting examples.

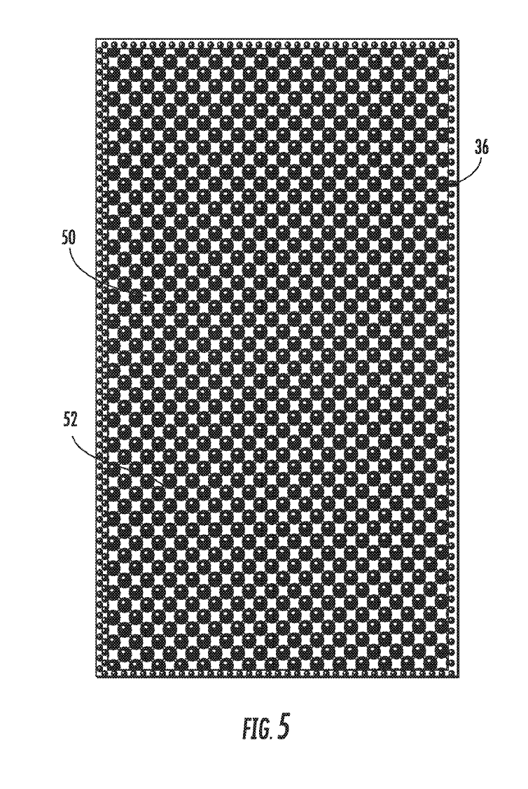

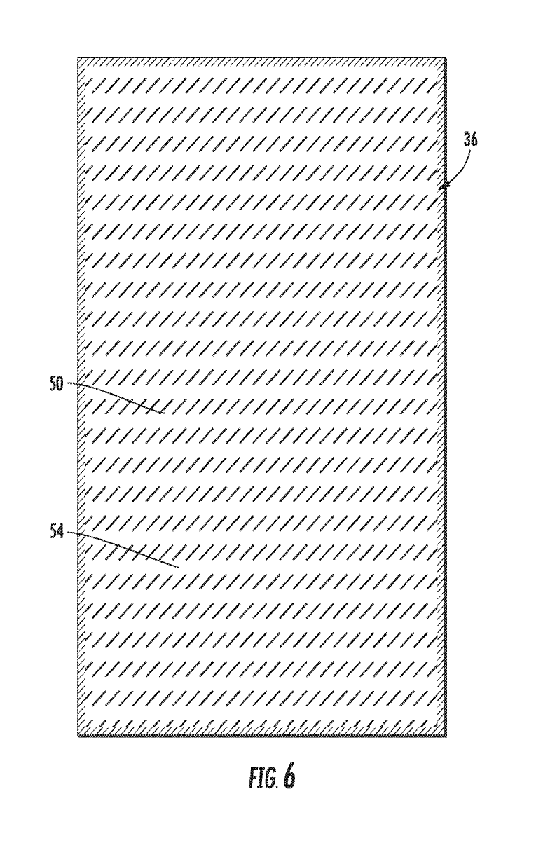

The surface features 36 of an embodiment include one or more raised features 50. The raised features 50 may be non-continuously applied to the brake pad 32 and/or the base 26 in one or more embodiments. As illustrated in FIG. 5, the raised features 50 include a plurality of dots 52 in one embodiment. As illustrated in FIG. 6, the raised features 50 include a plurality of line segments 54 in an embodiment. In particular embodiments, the dots 52, the line segments 54, and/or any other raised feature 50 may be finished, machined, or otherwise modified to form an even or flat rail facing surface 30. In additional embodiments, the dots 52, the line segments 54, and/or any other raised feature 50 is not finished, machined, or otherwise modified following formation and/or deposition. It will be appreciated that any combination of different surface features 36 and methods of forming the various surface features 36 may be included in a brake pad 32 of an embodiment, and such combinations form part of the present disclosure.

In some embodiments, the surface features 36 may be added to the brake pad friction surface 38 by machining (i.e., cutting the brake pad friction surface 38 into the desired surface feature). In other embodiments, the brake shoe base 26 may be pre-machined to have the desired surface features 36 disposed thereon. As the brake pad material is fuse bonded onto the flat surfaces and into the grooves of the brake shoe base 26, the desired surface features 36 are created on the brake pad friction surface 38.

In an embodiment, as shown in FIG. 4, an interface layer 40 is fuse bonded between the brake shoe base 26 and the brake pad 32. In an embodiment, the interface layer 40 is chosen from the group consisting of chrome, iron, nickel, nickel alloys, cobalt, and cobalt alloys. The interface layer 40 is configured to provide metallurgical compatibility for the fuse bonded brake pad 32.

It will therefore be appreciated that the present embodiments include a molybdenum alloy based brake pad 32 fuse bonded to a brake shoe base 26 to reduce the amount of high friction material required for effective operation to stop the elevator car 14; thus, reducing the costs of the elevator system 10.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. An elevator safety brake for stopping an elevator car, the brake comprising:
a brake shoe including a base; and
a brake pad disposed on the base, wherein the brake pad includes a rail contacting friction surface for contacting an elevator guide rail surface, wherein the brake pad is fuse bonded to the base;
wherein the brake pad is chosen from a group consisting of: molybdenum and molybdenum alloys.

2. The elevator safety brake of claim 1, wherein the base comprises a high compressive strength structural alloy.

3. The elevator safety brake of claim 2, wherein the high compressive strength structural alloy is chosen from a group consisting of: steel and cast iron.

4. The elevator safety brake of claim 2, wherein the brake pad is fuse bonded to the brake base via a fusion welding process.

5. The elevator safety brake of claim 4, wherein the fusion welding process comprises an arc welding process.

6. The elevator safety brake of claim 1, further comprising an interface layer disposed between the base and the brake pad, wherein the interface layer is fuse bonded to the base and the brake pad.

7. The elevator safety brake of claim 1, wherein the interface layer is chosen from a group consisting of: chrome, iron, nickel, nickel alloys, cobalt, and cobalt alloys.

8. The elevator safety brake of claim 1, wherein the rail contacting friction surface includes surface features disposed thereon, wherein the surface features are configured to provide at least one of increased friction of the brake pad and wear indication of the brake pad.

9. The elevator safety brake of claim 8, wherein the surface features include at least one raised feature deposited onto at least one of the brake pad and the base.

10. The elevator safety brake of claim 9, wherein the at least one raised feature is non-continuously applied to at least one of the brake pad and the base.

11. The elevator safety brake of claim 9, wherein the at least one raised feature includes a plurality of dots.

12. The elevator safety brake of claim 9, wherein the at least one raised feature includes a plurality of line segments.
